(19) United States
(12) Patent Application Publication
(10) Pub. No.: US 2023/0257594 A1
(43) Pub. Date: Aug. 17, 2023

(54) CORROSION RESISTANT COATING FOR MARINE ENGINEERING CONCRETE AND A PREPARATION METHOD

(71) Applicant: GUILIN UNIVERSITY OF TECHNOLOGY, GUILIN (CN)

(72) Inventors: YANG MING, GUILIN (CN); PING CHEN, GUILIN (CN); LING LI, GUILIN (CN); CHENG HU, GUILIN (CN); QING LI, GUILIN (CN); XUANDONG CHEN, GUILIN (CN); RONGJIN LIU, GUILIN (CN); SHUNKAI LI, GUILIN (CN); YANRONG ZHAO, GUILIN (CN); JIAZHAN WEI, GUILIN (CN)

(21) Appl. No.: 18/304,315

(22) Filed: Apr. 20, 2023

Related U.S. Application Data
(63) Continuation of application No. PCT/CN2021/086628, filed on Apr. 12, 2021.

(30) Foreign Application Priority Data
Dec. 31, 2020 (CN) 202011638575.8

(51) Int. Cl. C09D 5/10; C09D 163/00; C09D 7/40; C09D 7/65; C09D 7/61; C09D 7/63; C09D 7/48; C09D 7/45; C09D 7/47; C09D 7/43; B01J 13/14; C04B 41/00; C04B 41/45; C04B 41/48; C04B 41/63

(52) U.S. Cl. CPC C09D 5/106; B01J 13/14; C04B 41/009; C04B 41/63; C04B 41/4539; C04B 41/4543; C04B 41/4853; C09D 7/43; C09D 7/45; C09D 7/47; C09D 7/48; C09D 7/61; C09D 7/63; C09D 7/65; C09D 7/69; C09D 7/70; C09D 163/00

(57) ABSTRACT

The invention discloses a corrosion resistant coating for marine engineering concrete and a preparation method thereof, the corrosion resistant coating being sprayed or brushed on the concrete surface after being uniformly mixed by component A and component B,wherein the component A is calculated by weight including: waterborne non-ionic epoxy resin, C10-C12 alkyl glycidyl ether, polyhedral oligomeric silsesquioxane, metal powder, magnesium aluminum hydrotalcite powder,dispersant,defoamer; and the component B is calculated by weight including: modified aromatic amine curing agent, C10-C12 alkyl glycidyl ether, self-healing micro capsules, leveling agent, antioxidant, adhesion promoter, and other additives. The corrosion resistant coating of the present invention has excellent adhesion and corrosion resistance, while being able to achieve self-healing of the corrosion-resistant coating and prevent the migration of chloride ions, thereby prolonging the service life of the concrete structure, so that it can be widely used for the protection of marine engineering concrete structures.

### CROSS REFERENCE TO RELATED APPLICATIONS

This application claims the benefit of Chinese Application CN202011638575.8 for a corrosion-resistant coating for marine engineering concrete and a preparation method (filed Dec. 31, 2020 at the China National Intellectual Property Administration, CNIPA). This application is a national stage filing under section 371 of International Application No. PCT/CN2021/086628 filed on April. 12, 2021, which is published in Chinese on Jul. 7, 2022 as WO2022141931A1, the disclosure of which are hereby incorporated by reference in their entirety.

### FIELD OF THE INVENTION

The invention pertains to the field of concrete protection, in particular to a corrosion resistant coating for marine engineering concrete and a preparation method thereof.

### BACKGROUND OF THE INVENTION

Concrete is widely used in harbor engineering, bridge, underground engineering and foundation construction. However, the concrete structure is still affected by the external environment and is prone to failure, which can also cause major accidents. According to the environment in which the concrete is applied, there are complex and diverse reasons. Marine engineering is the focus of development this year, and the durability, safety and service life of marine concrete structures have always been the focus of research. Due to the infiltration of chloride ions in the environmental medium or raw materials into the concrete, the corrosion and expansion of steel bars cause the concrete to crack and damage, significantly reducing the durability of the concrete structure.

The main medium of damage to concrete structure is water. Because concrete is not strictly solid, but has certain pores and rough surface, and the medium in water brings CO2 which will cause carbonization,while the erosion of various anions in seawater will seriously corrode the internal steel bars. On one hand, the improvement of concrete composition is one of the measures to improve the durability of concrete structure, and on the other hand, it is to coat the concrete surface with corrosion-resistant coating to prevent the intrusion of harmful medium. Therefore, the service life of concrete depends to a large extent on the performance of the coating. How to seek more effective protection is still the direction and focus of existing technology research.

### SUMMARY OF THE INVENTION

The purpose of the invention is to solve the problems in the prior art. In accordance with an aspect of the embodiment, there is provided a corrosion resistant coating for marine engineering concrete thereof. The corrosion resistant coating has excellent adhesion and corrosion resistance, while it can achieve self-healing of the corrosion-resistant coating and prevent the migration of chloride ions, thereby prolonging the service life of the concrete structure.

In accordance with one aspect of the embodiment, a corrosion resistant coating for marine engineering concrete, the corrosion resistant coating being sprayed or brushed on the concrete surface after being uniformly mixed by component A and component B,comprising: the component A calculated by weight including: 80-100 parts of waterborne non-ionic epoxy resin, 5-10 parts of C10-C12 alkyl glycidyl ether, 1-5 parts of polyhedral oligomeric silsesquioxane, 2-3 parts of metal powder, 1-2 parts of magnesium aluminum hydrotalcite powder,0.1-0.5 parts of dispersant,0.1-0.5 parts of defoamer; the component B calculated by weight including: 50-70 parts of modified aromatic amine curing agent, 5-10 parts of C10-C12 alkyl glycidyl ether, 5-10 parts of self-healing microcapsules, 1-3 parts of leveling agent, 1-5 parts of antioxidant, 0.1-1 parts of adhesion promoter, and 1-3 parts of other additives.

Alternatively, the polyhedral oligomeric silsesquioxane is further configured to be tridecafluorooctyl propyl polyhedral oligomeric silsesquioxane or dodecafluoroheptylpropyl polyhedral oligomeric silsesquioxane.

Alternatively, the mental powder is configured to be zinc powder or magnesium powder;and the particle size of the magnesium-aluminate hydrotalcite powder is 10-20 µm.

Alternatively, the dispersant is selected from one or more of polyoxyethylene isodecyl ethe and polyoxyethylene styryl phenyl ether; the defoamer is an organic silicone defoamer; the leveling agent is an organic silicone polyether copolymer.

Alternatively, the self-healing microcapsules is prepared as follows: disperse 0.5-1 g dodecylbenzene sulfonic acid in 500 mL of deionized water, slowly add 30-50 g tung oil to form an emulsion while stirring, and add 15-20 g urea and 5-10 g hexamethoxy melamine resin after 5-10 minutes; then add 3-5 g ammonium chloride and 3-5 g resorcinol, drop dilute hydrochloric acid to adjust the emulsion pH to 5.5-6.5 after continuing stirring for 10-20 minutes, and then raise the temperature up to 60-65° C.for reaction for 60-120 min after adding 10-15 g saturated formaldehyde solution and 3-5 drops of octanol; when the reaction is finished, stop stirring and being filtered after standing for 5-10 minutes, and obtain the self-healing microcapsules by drying at 30-50° C. after washing the filtered material.

Alternatively, the antioxidant is chosen from one or more of 4-tert-butylcatechol, 2-tert-butylhydroquinone,2,6-di-tert-butyl-p-cresol,2,2-methylene-bis(4-methyl-6-tert-but ylphenol) .

Alternatively, the adhesion promoter is configured to be BYK-4511 or AP-507.

Alternatively, the other additives include one or more of thickeners and ultraviolet absorbents.

Alternatively, the thickener is chosen from one or more of ethylcellulose, hydroxymethylcellulose, hydroxyethylcellulose, carboxymethylcellulose; and the ultraviolet absorbent is selected from one or more of 2-hydroxy-4-octyloxybenzophenone,2-hydroxy-4-methoxybenzophenone,2-(2-hydroxy-3, 5-di-tert-butylphenyl)-5-chlorobenzotriazole.

In accordance with another aspect of the embodiment, a method for preparing a corrosion resistant coating for marine engineering concrete as defined above, including the following steps: (1) cleaning the concrete surface; (2) adding the dispersant, the metal powder, and the magnesium aluminum hydrotalcite powder into the reactor in sequence, starting stirring, and adding the waterborne non-ionic epoxy resin and the C10-C12 alkyl glycidyl ether after raising the temperature up to 30-50° C., then adding defoamer, and the component A being obtained after stirring for 20-30 min and vacuuming deaeration ; (3) adding the modified aromatic amine curing agent and 5-10 parts of C10-C12 alkyl glycidyl ether into the reactor, starting stirring, and heating to 70-80° C., after stirring to dissolve it completely, slowly adding the self-healing microcapsules, and then cooling to room temperature, adding the leveling agent, the antioxidant, the adhesion promoter, and the other additives in sequence, stirring for 20-30 min to obtain the component B; (4) mixing the component A and the component B in equal volume and stirring evenly; (5) spraying or brushing the mixture of step (4) on the concrete surface, repeating spraying or brushing 2-3 times after drying, and after drying, maintaining it for 2 to 3 days at 25 to 30° C. and 50 to 70% relative air humidity.

The following is an explanation of the functions and principles of each component of the invention: the tridecafluorooctyl propyl polyhedral oligomeric silsesquioxane or the dodecafluoroheptylpropyl polyhedral oligomeric silsesquioxane is an inorganic cage-like skeleton containing Si-O-Si with excellent thermal stability and fluorine atoms in its side groups. Its special three-dimensional nanostructure makes itself with excellent hydrophobic and oleophobic attributes. On the one hand, the side groups of this component make the coating surface have good hydrophobicity, which to some extent can prevent water molecules from infiltrating into the concrete structure through the coating, thus reducing the corrosion of the overall concrete and steel structure by the corrosive medium; on the other hand, this type of polyhedral oligomeric silsesquioxane can further improve the cross-linking degree of waterborne non-ionic epoxy resin, forming a hybrid epoxy resin, thus enhancing the adhesion, tensile strength and fracture strength of the coating to prevent the coating from cracking under harsh environment.

The present invention can improve the aging resistance and high temperature stability of the material through the interaction of antioxidants and ultraviolet absorbents, which will effectively increase the working life of the corrosion resistant coating.

The hydrotalcite powder is a layered double dihydroxyl metal hydroxide composed of positively charged metal hydroxide layers and inter-layer anions with negative charges. With a large specific surface area and pore size, it is easily accessible to guest molecules. And after calcination, it will lose inter-layer anions and water, and can obtain calcined products with high specific surface area, which can be reduced to the original layered structure by re-fixing anions. At the same time, the inter-layer anions of the hydrotalcite powder have migration and ion exchange characteristics, and the inter-layer anions can be replaced by other anions in the medium. Therefore, the hydrotalcite powder is a good chlorine ion fixer, which can be uniformly dispersed in the coating to effectively adsorb chlorine ions and further prevent chlorine ions from penetrating the coating into the concrete structure.

The present invention adds self-healing microcapsules to the coating, and the micro-capsules encapsulated in the coating rupture under external force, and the repairing agent inside the micro-capsules flows out. The repairing agent is transformed into cracks with capillaries and then undergoes a polymerization reaction to complete the self-healing process. By suppressing the generation of cracks to ensure the density of the coating, the corrosion resistance of the coating is effectively improved.

On the one hand, this invention improves the corrosion resistance of concrete surface by coating a dense protective coating through the interaction of the above substances; on the other hand, it combines with the principle of cathodic protection, adding low-potential metal powder such as zinc or magnesium in the coating, which can easily form a cathodic protection circuit in the marine environment, further improving the corrosion resistance of the coating.

Compared with prior art, the present invention has the following beneficial effects:

1.Although there are many researches on improving the corrosion resistance of coating by using self-healing micro-capsules in existing technologies, few technologies combine cathodic protection and self-healing micro-capsules. The present invention first combines the two to prepare a corrosion-resistant coating for marine engineering concrete.

2.The characteristics of the polyhedral oligomeric silsesquioxane in the present invention makes the coating have excellent adhesion, and further cooperating with the use of adhesion promoters to form a firmly bonded coating on the rough concrete structure surface.

3. The coating of the present invention has excellent adhesion and corrosion resistance, while being able to achieve self-healing of the corrosion-resistant coating and prevent the migration of chloride ions, thereby prolonging the service life of the concrete structure. It can be widely used for the protection of marine engineering concrete structures, and can also be used for the protection of concrete structures in general environment.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 shows the Tafel polarization curve of the corrosion-resistant coating prepared in the First Embodiment, and the First to the Third Comparison.

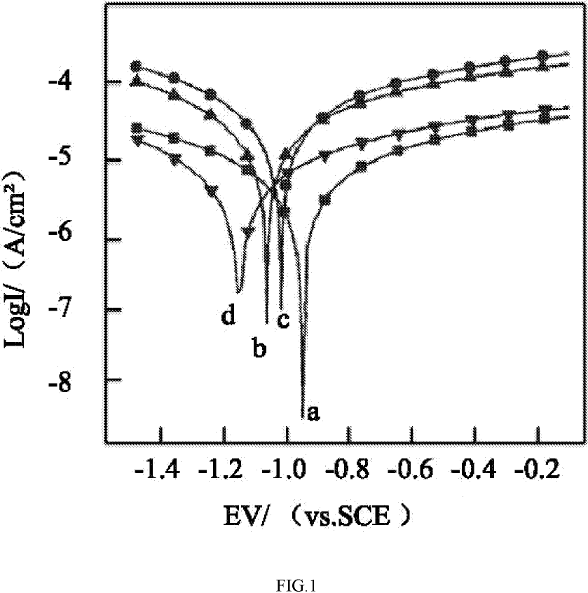

### DETAILED DESCRIPTION OF THE INVENTION

The present invention will become more fully understood from the detailed description given herein below and the accompanying drawings which are given by way of illustration only, and thus are not limitative of the present invention. The invention will be further described below in details with reference to the figures and embodiments.

It should be explained that the term “first” and “second” in the description, claims and the above drawings of the present invention are used to distinguish similar objects, instead of describing specific sequences or order.

### The First Embodiment

A corrosion resistant coating for marine engineering concrete, the corrosion resistant coating being sprayed or brushed on the concrete surface after being uniformly mixed by component A and component B,comprising:
the component A is calculated by weight including: 80 parts of waterborne non-ionic epoxy resin, 5 parts of C10 alkyl glycidyl ether, one part of the tridecafluorooctyl propyl polyhedral oligomeric silsesquioxane, 2 parts of zinc powder, 1 part of magnesium aluminum hydrotalcite powder,0.1 part of dispersant polyoxyethylene isodecyl ethe,0.1 part of organic silicone defoamer;
the component B is calculated by weight including: 50 parts of modified aromatic amine curing agent, 5 parts of C10 alkyl glycidyl ether, 5 parts of self-healing microcapsules, one part of leveling agent organic silicone polyether copolymer, one part of antioxidant 4-tert-butylcatechol, 0.1 part of adhesion promoter BYK-4511, and one part of the ultraviolet absorbent 2-hydroxy-4-methoxybenzophenone.

The self-healing microcapsules is prepared as follows: disperse 0.5 g dodecylbenzene sulfonic acid in 500 mL of deionized water, slowly add 30 tung oil to form an emulsion while stirring, and add 15 g urea and 5 g hexamethoxy melamine resin after 5 minutes; then add 3 g ammonium chloride and 3 g resorcinol, drop dilute hydrochloric acid to adjust the emulsion pH to 5.5 after continuing stirring for 10 minutes, and then raise the temperature up to 60° C.for reaction for 120 min after adding 10 g saturated formaldehyde solution and 3 drops of octanol; when the reaction is finished, stop stirring and being filtered after standing for 5 minutes, and obtain the self-healing microcapsules by drying at 30° C. after washing the filtered material.

The specific preparation method of corrosion resistant coating is corresponding to the method described in the SUMMARY OF THE INVENTION.

### The Second Embodiment

A corrosion resistant coating for marine engineering concrete, the corrosion resistant coating being sprayed or brushed on the concrete surface after being uniformly mixed by component A and component B,comprising:
the component A is calculated by weight including: 90 parts of waterborne non-ionic epoxy resin, 8 parts of C11 alkyl glycidyl ether, 3 parts of the dodecafluoroheptylpropyl polyhedral oligomeric silsesquioxane, 2.5 parts of zinc powder, 1.5 parts of magnesium aluminum hydrotalcite powder,0.3 parts of dispersant polyoxyethylene styryl phenyl ether,0.3parts of organic silicone defoamer;
the component B is calculated by weight including: 60 parts of modified aromatic amine curing agent, 8 parts of C11 alkyl glycidyl ether, 7 parts of self-healing microcapsules, 1.5 parts of leveling agent organic silicone polyether copolymer, 5 parts of antioxidant 2,2-methylene-bis(4-methyl-6-tert-butylphenol), 0.7 parts of adhesion promoter AP-507, and 2 parts of the thickener carboxymethylcellulose.

The self-healing microcapsules is prepared as follows: disperse 0.8 g dodecylbenzene sulfonic acid in 500 mL of deionized water, slowly add 40 tung oil to form an emulsion while stirring, and add 17 g urea and 8 g hexamethoxy melamine resin after 7 minutes; then add 4 g ammonium chloride and 4 g resorcinol, drop dilute hydrochloric acid to adjust the emulsion pH to 6 after continuing stirring for 15 minutes, and then raise the temperature up to 60° C.for reaction for 100 min after adding 12 g saturated formaldehyde solution and 4 drops of octanol; when the reaction is finished, stop stirring and being filtered after standing for 8 minutes, and obtain the self-healing microcapsules by drying at 40° C. after washing the filtered material.

The specific preparation method of corrosion resistant coating is corresponding to the method described in the SUMMARY OF THE INVENTION.

### The Third Embodiment

A corrosion resistant coating for marine engineering concrete, the corrosion resistant coating being sprayed or brushed on the concrete surface after being uniformly mixed by component A and component B,comprising:
the component A is calculated by weight including: 100 parts of waterborne non-ionic epoxy resin, 10 parts of C12 alkyl glycidyl ether, 5 parts of the dodecafluoroheptylpropyl polyhedral oligomeric silsesquioxane, 3 parts of magnesium powder, 2 parts of magnesium aluminum hydrotalcite powder,0.5 parts of dispersant polyoxyethylene styryl phenyl ether,0.5parts of organic silicone defoamer;
the component B is calculated by weight including: 50 parts of modified aromatic amine curing agent, 10 parts of C12 alkyl glycidyl ether, 10 parts of self-healing microcapsules, 3 parts of leveling agent organic silicone polyether copolymer, 5 parts of antioxidant 2,6-di-tert-butyl-p-cresol, 0.5 parts of adhesion promoter AP-507, and 3 parts of the ultraviolet absorbent 2-hydroxy-4-methoxybenzophenone.

The self-healing microcapsules is prepared as follows: disperse 1 g dodecylbenzene sulfonic acid in 500 mL of deionized water, slowly add 50 tung oil to form an emulsion while stirring, and add 20 g urea and 10 g hexamethoxy melamine resin after 10 minutes; then add 5 g ammonium chloride and 5 g resorcinol, drop dilute hydrochloric acid to adjust the emulsion pH to 6.5 after continuing stirring for 20 minutes, and then raise the temperature up to 65° C. for reaction for 60 min after adding 15 g saturated formaldehyde solution and 5 drops of octanol; when the reaction is finished, stop stirring and being filtered after standing for 10 minutes, and obtain the self-healing microcapsules by drying at 50° C. after washing the filtered material.

The specific preparation method of corrosion resistant coating is corresponding to the method described in the SUMMARY OF THE INVENTION.

### The First Comparison

The first Comparison is the same as the first Embodiment, but the difference is that the first Comparison does not include the zinc powder.

### The Second Comparison

The second Comparison is the same as the first Embodiment, but the difference is that second Comparison does not include the self-healing microcapsules.

### The Third Comparison

The third Comparison is the same as the first Embodiment, but the difference is that the third Comparison does not include the zinc powder and the self-healing microcapsules.

1. Bonding test of the prepared concrete structure coating should be conducted according to the requirements of “Paint and Varnish Pull-off Adhesion Test” to test the adhesion effect of the corrosion-resistant coating. The adhesion between the coating and the concrete can be obtained by the pull-off test. The results are shown in Table 1.

2. Salt spray test should be conducted on the prepared concrete structure coating and the blank sample without corrosion-resistant coating. The concrete structure should be completely covered by the corrosion-resistant coating, and the salt spray source should be 5 wt%! NaCl in the salt spray box. After 1500 h of spraying, the concrete structure should be cut open and silver nitrate solution should be sprayed along the edge of the coating. The penetration depth of chloride ion should be recorded according to the appearance of white AgCl precipitation. The results are shown in Table 1.

TABLE 1

| | blank | first Embodiment | second Embodiment | third Embodiment | first Comparison | second Comparison | third Comparison |
|---|---|---|---|---|---|---|---|
| Adhesion Strength(MPa) | -- | 5.7 | 6.2 | 5.8 | 4.2 | 4.8 | 4.5 |
| Depth penetration of Cl⁻ (mm) | 1.2 | 0 | 0 | 0 | 0 | 0.3 | 0.5 |

From the adhesion strength data, it can be seen that the corrosion-resistant coating prepared by the present invention has high adhesion strength and can ensure that the coating is not easily detached under external environmental forces. Although not obvious, it can also be inferred from the comparison results that other components also have a certain degree of performance reduction for the overall performance.

In addition, the corrosion-resistant coating has excellent self-healing and blocking of chlorine ion migration characteristics, so that the corrosion-resistant coating can mostly block the erosion of chlorine ions. In the comparison of those without self-healing microcapsules, there are still certain cracks or pores on the concrete surface, which allow chlorine ions to penetrate the coating and infiltrating into the interior of the concrete. It can be seen that the application of self-healing microcapsules can repair the coating and ensure the compactness of the coating.

Carry out corrosion performance test on the corrosion-resistant coating of concrete structure for first Embodiment and Comparison1-3, using PARSTAT electrochemical workstation, a standard three-electrode system consisting of reference electrode as saturated calomel electrode, auxiliary electrode as high-purity graphite rod, and working electrode as the sample to be tested. The corrosion electrolyte is NaCl solution with 3.5% mass fraction, and the polarization curve of the sample is tested, where the curve a-d corresponds to the polarization curve of first Embodiment and Comparison 1-3 respectively. The corrosion potential and corrosion current density are obtained by extrapolation of Tafel curve and recorded in Table 2.

TABLE 2

| | | | | |
|---|---|---|---|---|
| | Embodiment1 | Comparison1 | Comparison2 | Comparison3 |
| corrosion potential (V) | -0.94 | -1.05 | -1.02 | -1.16 |
| corrosion current density (A) | 8.7×10⁻⁸ | 2.1×10⁻⁷ | 1.3×10⁻⁷ | 6.5×10⁻⁶ |

From the Tafle polarization curve and its fitting data, it can be seen that the corrosion-resistant coating prepared by the present invention has an amended corrosion potential and the corrosion current density is as low as 10⁻⁸, indicating that the coating has excellent corrosion resistance. In the coating without zinc powder, its corrosion potential is negative shift and the corrosion current density increases significantly, indicating that its corrosion resistance is worse. Moreover, for the coating without zinc powder and self-repairing microcapsule, the corrosion current density is larger than the negative shift, and the corrosion current density is as high as 10⁻⁶, which shows that the corrosion resistance of the coating is significantly reduced. It can be seen that the corrosion resistance of the coating can be significantly improved by the combined effect of self-healing of self-healing microcapsules and cathodic protection of the present invention.

The above embodiments, which are intended to enable those skilled in the art to understand the content of the disclosure and implement it accordingly, are merely for describing the technical concepts and features of the disclosure, and the scope of patent application of the disclosure cannot be defined only by the embodiments, i.e., any equivalent variations or modifications made in accordance with the spirit disclosed by the disclosure still fall within the scope of claims of the disclosure.

What is claimed is:

1. A corrosion resistant coating for marine engineering concrete, the corrosion resistant coating being sprayed or brushed on the concrete surface after being uniformly mixed by component A and component B,comprising:
the component A calculated by weight including: 80-100 parts of waterborne non-ionic epoxy resin, 5-10 parts of C10-C12 alkyl glycidyl ether, 1-5 parts of polyhedral oligomeric silsesquioxane, 2-3 parts of metal powder, 1-2 parts of magnesium aluminum hydrotalcite powder,0.1-0.5 parts of dispersant,0.1-0.5 parts of defoamer;
the component B calculated by weight including: 50-70 parts of modified aromatic amine curing agent, 5-10 parts of C10-C12 alkyl glycidyl ether, 5-10 parts of self-healing micro capsules, 1-3 parts of leveling agent, 1-5 parts of antioxidant, 0.1-1 part of adhesion promoter, and 1-3 parts of other additives.

2. The corrosion resistant coating as defined in claim 1, wherein the polyhedral oligomeric silsesquioxane is further configured to be tridecafluorooctyl propyl polyhedral oligomeric silsesquioxane or dodecafluoroheptylpropyl polyhedral oligomeric silsesquioxane.

3. The corrosion resistant coating as defined in claim 1, wherein the mental powder is configured to be zinc powder or magnesium powder; and the particle size of the magnesium-aluminate hydrotalcite powder is 10-20 µm.

4. The corrosion resistant coating as defined in claim 1, wherein the dispersant is selected from one or more of polyoxyethylene isodecyl ethe and polyoxyethylene styryl phenyl ether; the defoamer is an organic silicone defoamer; the leveling agent is an organic silicone polyether copolymer.

5. The corrosion resistant coating as defined in claim 1, wherein wherein the self-healing micro capsules is prepared as follows: disperse 0.5-1 g dodecylbenzene sulfonic acid in 500 mL of deionized water, slowly add 30-50 g tung oil to form an emulsion while stirring, and add 15-20 g urea and 5-10 g hexamethoxy melamine resin after 5-10 minutes; then add 3-5 g ammonium chloride and 3-5 g resorcinol, drop dilute hydrochloric acid to adjust the emulsion pH to 5.5-6.5 after continuing stirring for 10-20 minutes, and then raise the temperature up to 60-65° C.for reaction for 60-120 min after adding 10-15 g saturated formaldehyde solution and 3-5 drops of octanol; when the reaction is finished, stop stirring and being filtered after standing for 5-10 minutes, and obtain the self-healing micro capsules by drying at 30-50° C. after washing the filtered material.

6. The corrosion resistant coating as defined in claim 1, wherein the antioxidant is chosen from one or more of 4-tert-butylcatechol, 2-tert-butylhydroquinone, 2,6-di-tert-butyl-p-cresol, 2,2-methylene-bis(4-methyl-6-tert-butylphenol).

7. The corrosion resistant coating as defined in claim 1, wherein he adhesion promoter is configured to be BYK-4511 or AP-507.

8. The corrosion resistant coating as defined in claim 1, wherein the other additives include one or more of thickeners and ultraviolet absorbents.

9. The corrosion resistant coating as defined in claim 8, wherein the thickener is chosen from one or more of ethylcellulose, hydroxymethylcellulose, hydroxyethylcellulose, carboxymethylcellulose; and the ultraviolet absorbent is selected from one or more of 2-hydroxy-4-octyloxybenzophenone,2-hydroxy-4-methoxybenzophenone,2-(2-hydroxy -3,5-di-tert-butylphenyl)-5-chlorobenzotriazole.

10. A method for preparing a corrosion resistant coating for marine engineering concrete as defined in claim 1, including the following steps:
(1) cleaning the concrete surface;
(2) adding the dispersant, the metal powder, and the magnesium aluminum hydrotalcite powder into the reactor in sequence, starting stirring, and adding the waterborne non-ionic epoxy resin and the C10-C12 alkyl glycidyl ether after raising the temperature up to 30-50° C., then adding defoamer, and the component A being obtained after stirring for 20-30 min and vacuuming deaeration ;
(3) adding the modified aromatic amine curing agent and 5-10 parts of C10-C12 alkyl glycidyl ether into the reactor, starting stirring, and heating to 70-80° C., after stirring to dissolve it completely, slowly adding the self-healing micro capsules, and then cooling to room temperature, adding the leveling agent, the antioxidant, the adhesion promoter, and the other additives in sequence, stirring for 20-30 min to obtain the component B;
(4) mixing the component A and the component B in equal volume and stirring evenly;
(5) spraying or brushing the mixture of step (4) on the concrete surface, repeating spraying or brushing 2-3 times after drying, and after drying, maintaining it for 2 to 3 days at 25 to 30° C. and 50 to 70% relative air humidity.

11. A method for preparing a corrosion resistant coating for marine engineering concrete as defined in claim 2, including the following steps:
(1) cleaning the concrete surface;
(2) adding the dispersant, the metal powder, and the magnesium aluminum hydrotalcite powder into the reactor in sequence, starting stirring, and adding the waterborne non-ionic epoxy resin and the C10-C12 alkyl glycidyl ether after raising the temperature up to 30-50° C., then adding defoamer, and the component A being obtained after stirring for 20-30 min and vacuuming deaeration ;
(3) adding the modified aromatic amine curing agent and 5-10 parts of C10-C12 alkyl glycidyl ether into the reactor, starting stirring, and heating to 70-80° C., after stirring to dissolve it completely, slowly adding the self-healing micro capsules, and then cooling to room temperature, adding the leveling agent, the antioxidant, the adhesion promoter, and the other additives in sequence, stirring for 20-30 min to obtain the component B;
(4) mixing the component A and the component B in equal volume and stirring evenly;
(5) spraying or brushing the mixture of step (4) on the concrete surface, repeating spraying or brushing 2-3 times after drying, and after drying, maintaining it for 2 to 3 days at 25 to 30° C. and 50 to 70% relative air humidity.
